(19) United States
(12) Patent Application Publication
(10) Pub. No.: US 2017/0364889 A1
(43) Pub. Date: Dec. 21, 2017

(54) RETAIL CHECKOUT SYSTEMS AND METHODS

(71) Applicant: Wal-Mart Stores, Inc., Bentonville, AR (US)

(72) Inventors: Vibhor RASTOGI, Meerut City (IN); Preetam PURBIA, Udaipur (IN); Vivek KUMAR, Muzaffarpur (IN); Praveen DEVERACHETTY, Hyderabad (IN); Lalit GANDOTRA, Bangalore (IN); Soumya Ranjan MOHANTY, Cuttack (IN); Dinesh Amarnath RAO PISE, Bangalore (IN)

(21) Appl. No.: 15/525,809

(22) PCT Filed: Dec. 28, 2015
(86) PCT No.: PCT/US15/67563

§ 371 Date: May 10, 2017

Related U.S. Application Data
(60) Provisional application No. 62/098,390, filed on Dec. 31, 2014.

(51) Int. Cl. G06Q 20/20; G06Q 30/06; G06F 17/30

(52) U.S. Cl. CPC G06Q 20/204; G06Q 30/0633; G06Q 30/0631; G06Q 20/203; G06F 17/30964

(57) ABSTRACT

Provided are a retail checkout system and method. A customer record includes registered identification information related to a store customer. An input device receives unique customer identification information from a purchaser card of the store customer. A customer identification analyzer verifies that the received unique customer identification information is included in the registered identification information of the customer record. An order linking module associates purchase data with the unique customer identification information of the purchaser card. A customer record processor updates the customer record to include the purchase data.

### RELATED APPLICATIONS

This application claims the benefit of U.S. Ser. No. 62/098,390, filed Dec. 31, 2014, the content of which is incorporated herein by reference, in its entirety.

### FIELD OF THE INVENTION

The invention relates generally to shopping, and more specifically, to systems and methods for purchasing store items.

### BACKGROUND

There are two primary shopping options available to a customer who wishes to purchase a store item. The first includes the physical presence of the customer at a retail establishment, referred to as a “brick-and-mortar” store. Here, the customer can retrieve item of interests from in-store inventory if the items are available, and purchase the items at a checkout counter at the store. The second shopping option is referred to as “online shopping” where the customer can purchase store items over the internet. Here, the purchased items are mailed to a location designated by the online customer.

### BRIEF SUMMARY

In one aspect, provided is a retail checkout system, comprising: a customer registration database that stores a plurality of customer records, wherein a customer record of the plurality of customer records includes registered identification information related to a store customer; an input device that receives unique customer identification information from a purchaser card of the store customer; a customer identification analyzer that verifies that the received unique customer identification information is included in the registered identification information of the customer record; an order linking module that associates purchase data with the unique customer identification information of the purchaser card; and a customer record processor that updates the customer record to include the purchase data.

In another aspect, provided is a checkout kiosk, comprising: an input device that receives unique customer identification information from a purchaser card; a customer identification analyzer that verifies the received unique customer identification information; an order linking module that associates purchase data with the unique customer identification information of the purchaser card; and a customer record processor that updates the customer record to include the purchase data.

In another aspect, provided is a method for purchasing store items, comprising: receiving at an input device unique customer identification information from a purchaser card; verifying the received unique customer identification information; associating purchase data with the unique customer identification information of the purchaser card; and updating the customer record to include the purchase data.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is an illustrative view of a retail store at which embodiments of the present inventive concepts are employed.

FIG. 2 is a block diagram of the retail checkout system in e of FIG. 1, in accordance with some embodiments.

FIG. 3 is a flow diagram illustrating a method for identifying a store customer, in accordance with some embodiments.

FIG. 4 is a flow diagram illustrating a method for registering a purchaser card with a store customer account, in accordance with some embodiments.

FIG. 5 is a flow diagram illustrating a method for purchasing at a store checkout, in accordance with sonic embodiments.

FIGS. 6A and 6B are flow diagrams illustrating a method for operating a retail checkout system, in accordance with some embodiments.

FIGS. 7-19 are screenshot images of a user interface of a retail checkout system, in accordance with some embodiments.

### DETAILED DESCRIPTION

Many store customers prefer to shop online, while other store customers prefer to be physically present at a brick-and-mortar when shopping, referred to as being offline. These customers enjoy walking about the store, perusing items of interest, etc. Other customers may shop at a store out of necessity since they do not own a home computer or smartphone, or have access to an internet service.

Online customers enjoy a customized and expedient shopping experience that is typically not offered at a brick-and-mortar store. For example, online customers can order items online at any time, thereby avoiding the time-consuming effort of being physically present at the store to select items of interest from shelves and waiting in line at the store checkout to purchase the items especially at peak times. Also, online customers typically have immediate access to their purchase history, and can receive a display of recommended items for purchase based on shopping patterns or other purchase history information.

Brick-and-mortar stores often provide its customers an opportunity to participate in a “loyalty program” or other store-specific membership program, where a member customer can receive a membership card, credit card, debit card, rewards card, gift card, loyalty card, or a combination thereof. To receive an abovementioned store card, a customer must fill out an application form and undergo an authorization process as a condition for enrollment. Once accepted into the program, the customer receives a physical card with a unique card identification number. The customer may keep the card in a wallet or purse, or the card may be configured for a key ring or the like. The customer may produce the membership card to purchase items, or to collect points, credits, or related rewards that may be redeemed in the future.

In general, each retailer operates a store-specific customer loyalty program. A customer belonging to loyalty programs with multiple retailers and wishing to visit multiple stores therefore needs to carry in his or her position multiple membership cards, one for each retail establishment. In addition to membership cards, a typical customer typically carries in possession other cards such as a driver's license, debit cards, credit cards, passport, a social security card, health insurance card, and/or other identification cards. These other cards are typically collocated with store membership cards in a wallet, purse, and so on.

The present inventive concepts combine the benefits of offline shopping with online features, and address problems faced by online, or internet, customers and brick-and-mortar customers alike by introducing a retail checkout system and method that allows a store customer's purchaser cards, i.e., debit card, credit card or related charge card, driver's license, passport, health insurance card, business card, key ring card, and/or other card and so on to be used instead of a store-specific membership card for identifying the store customer as being enrolled, or otherwise registered at the store, and for associating purchases made by the customer at the store to the purchaser card. For example, some purchaser cards such as debit cards and credit cards may be used to purchase items at the store, while other purchaser cards such as a driver's license may be used as identification. Here, any and all purchaser cards, including but not limited to debit and credit cards, drivers licenses, business cards, and so on, can each be registered under a single customer membership account at the store, so that the customer does not have to carry an additional card, i.e., a store membership card, for use when making purchases at the store. Accordingly, the customer can use any purchaser card to enjoy the same benefits as those typically enjoyed by a store membership card-holding customer when a purchase is made at a store checkout counter, such as the accumulation and redeeming of points for each purchase of store items, product discounts, and so on, but without the need of a separate membership card.

The retail checkout system and method in accordance with some embodiments permits a user to perform different purchase-related actions when the user is identified via a purchaser card as a registered store customer. For example, the customer can enjoy features that may include but not be limited to browsing through a purchase history, receiving at a checkout a list of recommended store items based on prior purchases and/or captured information about customer buying habits, accessing store inventory, and receiving item delivery and pick route options,

In some embodiments, the systems and methods of the present inventive concepts can be deployed as part of a kiosk or the like at the store's checkout counter, for example, in a “fast lane” at the store checkout. In other embodiments, the systems and methods of the present inventive concepts can be deployed as a public kiosk or the like, for example, positioned at an airport, shopping mall, rail station, or any location having access to a communication network, such as the internet.

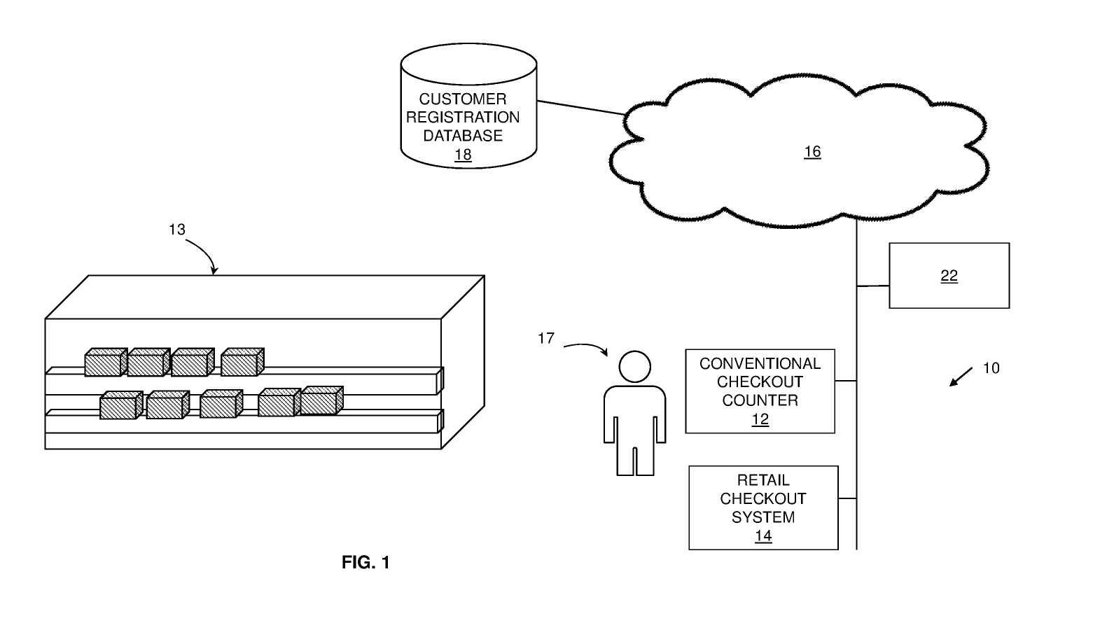

FIG. 1 is an illustrative view of a retail store 10 at which embodiments of the present inventive concepts are employed. The store 10 can be a supermarket, super store, small family store, or any other brick-and-mortar retail establishment which offers, and the customers may receive, for example, purchase or rent, products and/or services, or any entity where a commercial transaction may be performed.

The store 10 includes a plurality of shelves 13 or the like on which a plurality of items for purchase are located. A customer 17 can physically retrieve one or more products directly from the shelves 13. The customer 17 may have a shopping cart or other carrying device for transporting the retrieved products from the shelves 13 to a checkout counter 12 for purchase. Alternatively, the customer 17 may proceed to the retail checkout system 14 without items for purchase physically at hand. Here, the customer 17 may activate a picking option from the retail checkout system 14 for establishing a mode and manner of delivery of the purchased items to the customer 17.

In some embodiments, as illustrated in FIG. 1, the retail checkout system 14 is co-located with the checkout counter 12 at an exit region of the store 10. The retail checkout system 14 can be implemented as part of a cashier-staffed or unstaffed checkout counter 12 having a point-of-sale (POS) system or the like.

In other embodiments, the system 14 can be part of a kiosk or other computer, which in turn can be located at the store 10, or at a shopping mall, an airport, university, or other public location accessible by new and existing customers. In other embodiments, instead of deployment at the store 10 or public kiosk, the retail checkout system 14 can be deployed and used for viewing items at an online payment processing system of an Internet store that is part of, or otherwise in communication with, a retail establishment. The items may be located at the store shelves 13, or located at a warehouse or related facility. The retail checkout system 14 may display delivery options for the customer 17.

The store 10 may communicate with a customer registration database 18 and an item catalog server 22 as welt as other supporting systems to manage and support sales at the store 10 via a network 16, for example, a public switched telephone network (PSTN), a mobile communications network, a data network, such as a local area network (LAN) or wide area network (WAN), or a combination thereof, or other communication networks known to those of ordinary skill in the art. The item catalog server 22 can provide item information to the checkout counter 12 and/or retail checkout system 14 such as price and quantity of available items, item descriptions, or other item information.

The customer registration database 18 stores purchaser information from the store 10 and/or a plurality of other stores. For example, several stores may be part of a chain, and purchaser information from the stores' customers may be stored at the customer registration database 18. A customer record can be generated at the customer registration database 18 that links the store customer's purchaser cards, more specifically, unique customer identifications on the cards, with each other as well as with purchase information with respect to each card. The customer record can include customer identification information such as name, address, phone number, date of birth, gender, account number, and so on.

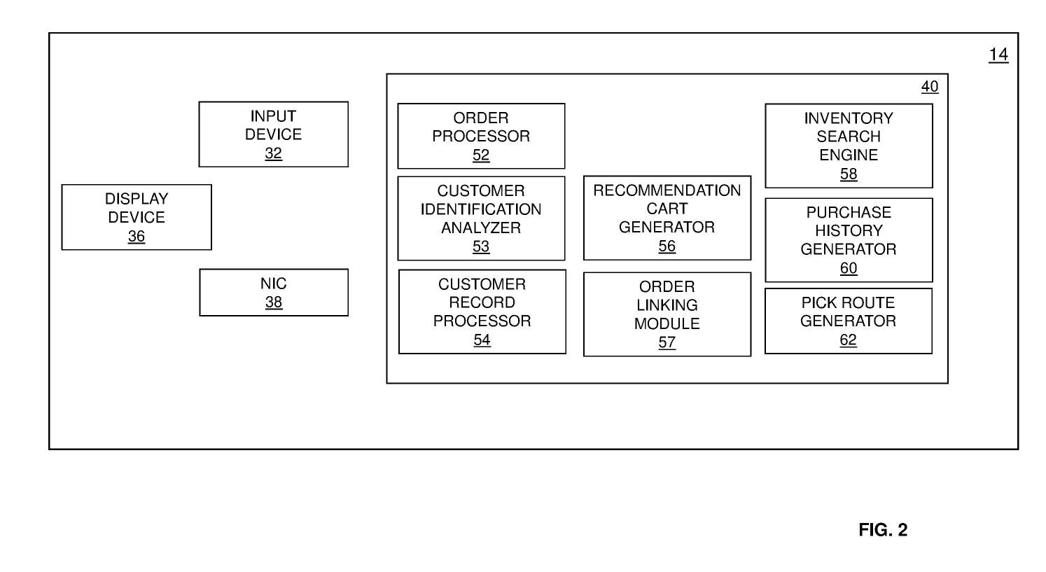

FIG. 2 is a block diagram of the retail checkout system 14 shown in FIG. 1.

The retail checkout system 14 can include an input device 32, a display device 36, a network interface card (NIC) 38, and a memory 40, which communicate with each other via a data/control bus or related data connector (not shown). Some or all of the components of the retail checkout system 14 can coexist under a single hardware device, or can be separate from each other, for example, located on different computer platforms. In some embodiments, some or all of the customer registration database 18 is part of the retail checkout system 14.

The input device 32 can read unique customer identification information from a purchaser card. Unique customer identification information can include but not be limited to a name, address, phone number, date of birth, credit or debit card number, account number, personal number (PIN), passport number, and/or other information that is associated with the user of the purchaser of the card. The input device 32 can include but not be limited to one or more of a magnetic card reader, barcode reader, or the like for reading the unique customer identification information on the purchaser card. In some embodiments, unique customer identification information may not be located on a card, but may instead be located on a barcode, QR code, or other location known to those of ordinary skill in the art where personal information may be stored, for example, on a keychain tag.

The input device 32 can also include a camera, microphone, sensor, and/or other devices for receiving information that uniquely identifies the customer 17, for example, biometric data such as an image of the customer's face, fingerprint, retina, or captures unique sound such as the customer's voice.

The memory 40 can include volatile memory, for example, random access memory (RAM) and the like, and/or non-volatile memory, for example, read-only memory (ROM), flash memory, and the like. The memory 40 can include removable and/or non-removable storage media implemented in accordance with methods and technologies known to those of ordinary skill in the art for storing data. Stored in the memory 40 can include program code, such as program code of one or more of an order processor 52, a customer identification analyzer 53, a customer record processor 54, a recommendation cart generator 56, an order linking module 57, an inventory search engine 58, a purchase history generator 60, and/or a pick route generator 62. Some or all of the order processor 52, customer record processor 54, recommendation cart generator 56, inventory search engine 58, purchase history generator 60, and/or pick route generator 62 are executed by one or more processors (not shown), and can coexist at the memory 40, or be separate from each other, for example, on different hardware devices.

The order processor 52 receives and processes data related to a purchase of one or more items of interest by the customer 17. The order processor 52 can communicate with a checkout counter 12, for example, a POS system at the checkout counter 12, where the customer 17 may purchase the items, for example, paying cash, using credit card, etc., in order to receive and process item purchase data for updating the customer record, establishing associations between purchases and user identification information on purchaser cards or the like, and so on. Alternatively, the customer 17 can purchase the items directly at the retail checkout system 14 instead of the checkout counter 12. Here, the input device 32 may include or otherwise communicate with a scanner such as a QR code or other barcode scanner, keyboard, and/or other POS device used at a conventional checkout for entering product identification information and for providing other POS functions known to those of ordinary skill in the art. For example, item barcode information, purchase receipt reference numbers, credit or debit card information, and/or other information relative to a purchase can be entered via the input device 32 to a hardware processor of the retail checkout system 14 that executes these functions.

The customer identification analyzer 53 determines whether there is a customer account at the customer registration database 18, and if so, whether there is a customer record at the customer account that includes at least one registered purchaser card. In particular, the customer identification analyzer 53 verifies whether a store customer is registered by comparing identifier information from a purchase card swiped or otherwise input to the input device 32 and contents of the database 18, in particular, customer records stored at the database 18. The customer identification analyzer 53 can therefore determine whether captured unique customer identification information is located in an existing customer account, for example, by accessing the database 18. The customer account preferably includes customer information such as name, address, account number, date of birth, phone number, gender, and/or other relevant information. Each account can have multiple customer records. Each record may be identified by at least one unique identification card in possession by the customer, such as a credit card, driving license, social security card, and so on. The customer identification analyzer 53 can identify the closest customer account based on the information provided by the purchaser card, for example, when the card is swiped through a reader during a purchase. This closest account can be verified with the customer record data in the event that more than one card is identified. The customer identification analyzer 53 can verify received unique customer identification information, for example, purchaser card information and/or biometric data, for comparison to a customer record that includes previously recorded information about the customer to confirm the identity of the customer.

The customer record processor 54 can receive an output from the order processor 52, the input device 32, and/or the order linking module 57. In particular, when there is no customer account at the customer registration database 18, and no prior history of use by the customer 17 at the store 10, the customer record processor 54 generates a new customer record from a combination of the customer identification information generated by the recognition device 34 and/or other identifier information such as a debit/credit card number, a passport, and customer purchase data received and processed by the order processor 52. In some embodiments, a customer record is generated for each purchaser card, e.g., credit card, driver's license, and so on. In other embodiments, a single customer record is generated by the customer record processor 54 for multiple purchase cards. The customer record processor 54 can also update an existing customer record when a new purchaser card is used by the same customer, and/or when new purchases are made by a registered purchaser card or a new card. In other words, the customer record processor 54 registers any and all purchaser cards with the customer account via customer records.

The recommendation cart generator 56 scans the customer registration database 18 and/or other repositories at the store 10 or remote location for customer purchase history data according to customer identification information in one or more customer records, and uses the customer sales history data to determine shopping patterns, customer interests, and so on. The recommendation cart generator 56 can generate a list of recommended items, also referred to as a recommendation cart or recommended shopping list, based on a combination of the customer record and the collected purchase history data. A current customer record can be updated to include the collected purchase history data, or a new customer record can be generated the associates collected purchase history data with customer identification information generated by the recognition device 34.

For example, when the customer 17 purchases items on a recurring basis such as milk, bread, and so on, the purchase data is captured, for example, the time of purchase, quantity and value of purchased items, and so on, and stored along with the associated customer identifier information at the customer registration database 18 or other storage location. The recommendation cart generator 56 can generate, prior to purchase, a recommended shopping list that is recurring in a regular routine, such as a daily routine or weekly routine. For example, the system 14 can determine that a customer 17 is a daily customer, and purchases a gallon of milk every day at the store 10. The recommended shopping list, when displayed at a user interface on the display device 36, includes a gallon of milk, which the customer 17 can select for purchase. The recommendation cart generator 56 provides user-configurable options, for example, permitting the customer to edit the recommendation cart to remove or add items from the cart. The customer 17 can access the recommendation cart from a user interface at the display device 36 and generate a list of items based on the customer purchase history, buying pattern and associated items that are bought by many customers, user preferences as well as item preferences. With this information, the customer 17 can edit the recommended cart to add/delete items. Once the cart is confirmed, then the customer 17 can proceed to the checkout, which may include a conventional POS, and/or perform order linking, registration, and/or other related operations described herein at the retail checkout system 12.

The order linking module 57 links a current purchase, for example, received by the order processor 52, to the card associated with that purchase, or more specifically, to the unique identifier information recorded on the card. This information can be provided to the record processor 54 which updates the record with this information.

Accordingly, a database, website, and/or data repository can include various records within that each correspond to an identifier of a different card or the like with features of the particular card, such as reward points, so that the various records can permit the customer to interchangeably use, via a communication network such as the internet, such cards in place of a membership card.

The inventory search engine 58 permits the customer to search for store inventory. In doing so, the inventory search engine 58 may communicate, for example, via the NIC 38, with the item catalog server 22, the customer registration database 18, and/or other source of data that stores inventory information. The inventory search engine 58 may generate for the display 36 a textbox or the like so that the customer may search for an item in store inventory, and to present a result, for example, a list of items that are available for the customer to purchase. The generated list of items can be added to a recommendation cart in response to the customer inquiry and/or customer purchase of the items.

The purchase history generator 60 communicates with the customer registration database 18 or other store device storing customer sales history data so that the customer may browse the purchase history and view recurring items. The purchase history generator 60 can generate this data for addition to a recommendation cart or the like that generates purchase recommendations.

The pick route generator 62 provides information for a customer to pick up an ordered item, for example, provides a mode of delivery of purchased items to the customer 17. The pick route generator 62 may generate an optimal pick route for the customer 17, which can include an aggregate map of locations of some or all items in the cart, online checkout, or other physical or electronic repository. The optimal route can include a preferable route, for example, based on minimum time and/or minimum distance between the item's location and the customer's location.

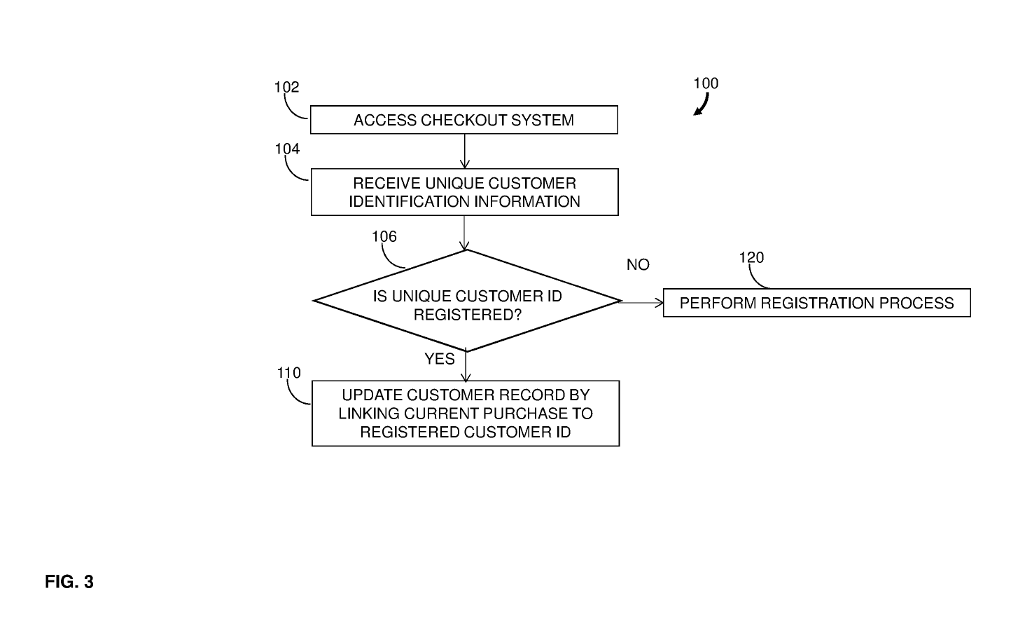

FIG. 3 is a flow diagram illustrating a method 100 for identifying a store customer identification, in accordance with some embodiments. Some or all of the method 100 can be performed at the store 10 illustrated in FIG. 1. Accordingly, in describing the method 100, reference is made to FIGS. 1 and 2. Alternatively, some or all of the method 100 can be performed at a kiosk or other public apparatus, such as an airport or shopping mall kiosk, Alternatively, some or all of the method 100 can be performed as part of an online payment processing system.

The customer 17 shops for items of interest, and proceeds to the checkout counter and/or the retail checkout system 14 at the store 10 to purchase the items. In some embodiments, the store is a brick-and-mortar store, but is not limited thereto. For example, the store can relate to a location such as a shopping mall, airport, and so on where inventory, or items of interest, are not present, but where the customer makes purchase of the items from a computer via the Internet.

While shopping in the store 10, the customer 17 carries one or more different purchaser cards. The method 100 can be initiated at block 102, by the customer accessing the retail checkout system 14 before, during, or after the purchase. A purchasing process may include each selected product being scanned by a bar code reader or other product identification technique. Information related to the purchase can be stored, for example, at the customer registration database 18, and as described herein linked to the purchaser card used by the customer 17 as part of the purchase.

The customer 17 may first receive a purchase receipt or other proof of purchase, for example, at checkout 12, and input to the retail checkout system 14 the purchase receipt or other proof of purchase information, which can be used for associating the current purchase information with a credit card or debit card used to purchase the items, or associated with another card or the like that includes identification information, for example, a driver's license. In embodiments where the customer 17 is not physically at the store 10, the customer 17 may proceed to a checkout screen, for example, at a kiosk, online payment processing system, or other computer device.

At block 104, the retail checkout system 14 receives unique customer identification information from a purchaser card or the like. Alternatively, the unique customer identification information may be provided in a different manner by the customer, for example, entered using a keyboard, mouse, or other input device. Unique customer identification information can include but not be limited to a name, address, phone number, credit or debit card number, identification number, passport number, and/or other information that is associated with the customer, who is assumed to be a user of the purchaser card.

In embodiments where the purchaser card is a credit card, debit card, or related bank card number or other identifier, the credit card, debit card, or the like can be used to purchase items as well as be used to establish membership of the customer 17 at the store 10. In other embodiments where the customer purchases the items with cash, another form of identification such as a driver's license, passport, health insurance card, business card, and so on, or a financial transaction account number such as a Paypal™ account, a routing number, and so on, may be used as an identifier for establishing membership of the customer 17 at the store 10. A credit card or debit card may also be used for electronically linking purchases, for example, via the Internet, with the customer account when cash is used to make the purchase. In other embodiments, a debit card or credit card can also be used to purchase items, and another purchaser card such a driver's license can be used to establish membership of the customer 17 at the store 10.

At decision diamond 106, a determination is made whether the unique customer identification information is registered with a customer account at the store 10. In embodiments where a debit card or credit card is used, the determination can be made as part of an authorization process. Registration can be based on one or more unique customer identification elements of the purchaser card, e.g., name, address, phone number, date of birth, and so on being identified and verified in a customer record stored at the customer registration database 18 or other data repository. Card registration can be performed by the customer record processor 54 of FIG. 2. The customer may have an existing account established at the store, for example, to receive advertisements, provide layaway services, provide credit services, and so on, or as part of the registration process 120 may create a new customer account for linking a card, as well as purchases made using the card, to the account. Each time the customer purchases items at the store, the customer record is updated to include data related to the customer purchase.

If the determination at decision diamond 106 establishes that the unique customer identification information of the particular card is registered, then the method. 100 proceeds to block 110, where the customer record is updated by linking the current purchase to the registered purchaser card, for example, which can be performed by the customer record processor 54 of FIG. 2. Otherwise, the method proceeds to block 120, where a registration process is performed.

The current purchase may be linked to the purchaser card by the customer providing a receipt indicating that the item is purchased. The purchase receipt can be provided at a checkout 12, or from the retail checkout system 14, or another device such as a fast checkout kiosk. Related proof of purchase information can equally apply, for example, a purchase confirmation displayed at a computer screen instead of, or in addition to a receipt. A credit card or debit card slip may serve as a purchase receipt. In linking the purchase to the purchaser card when updating the customer record, additional services may be generated. For example, gift coupons, recommendations, advertisements, and so on can be generated in connection with future purchases.

In some embodiments, the unique customer identification information may include one or more elements that do not match the customer record. For example, the customer record may include the name and address of the customer, and the unique customer identification information may include the same name, but a different address. Here, a process may be implemented that determines a probability of a match between the customer in possession of the purchaser card and the information about the customer stored in the customer store account, or customer record. A match can be established if the probability is greater than a predetermined threshold. A match can be based on a predetermined threshold, for example, established when three elements of the customer identification, e.g., name, address, and phone number, are determined to be the same as those in one or more customer records. If the match is established, the customer account is confirmed. If a match is not established, a list of customer accounts, and/or customer records in the customer accounts, can be displayed, for example, so that the customer can select the correct account and/or record.

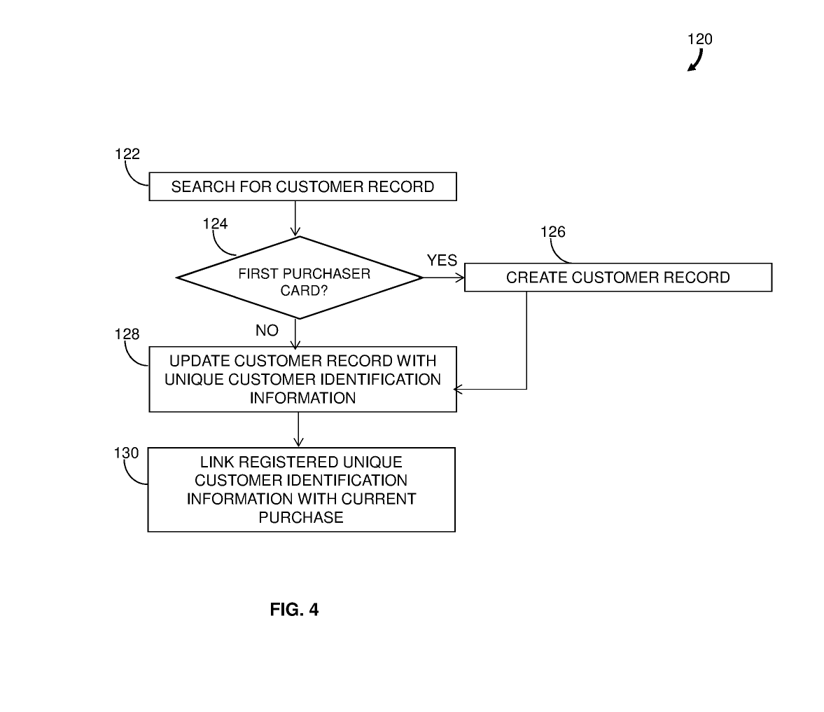

FIG. 4 is a flow diagram illustrating a method 120 for registering a purchaser card with a store customer account, in accordance with some embodiments. Some or all of the method 120 can be performed at the store 10 illustrated in FIG. 1. Accordingly, in describing the method 120, reference is made to FIGS. 1-3. Alternatively, some or all of the method 120 can be performed at a kiosk or other public apparatus, such as an airport or shopping mall kiosk connected to the internet. Alternatively, some or all of the method 120 can be performed as part of an online payment processing system.

Prior to performing the method 120, a determination has been made that a purchaser card submitted by the customer 17 has not been registered with a store account, for example, with customer information stored at the customer registration database 18 or other data repository.

At block 122, a search is performed for a customer record based on the acquired unique customer identification information provided with the purchaser card used with a current purchase transaction.

At decision diamond 124, a determination is made whether the purchaser card to be registered is the first purchaser card linked to the customer record. A determination can also be made whether a customer account exists, and if so, whether a customer record is present at the customer account.

If at decision diamond 124 a determine is made that that the purchaser card to he registered is the first or only purchaser card used by the customer 17 at the store 10 to date, then the method 100 proceeds to block 126, where a customer record 126 is created for any and all purchaser cards used by the customer 17. Otherwise, the method 100 proceeds to block 128, where the existing customer record is updated with the unique customer identification information retrieved from the purchaser card.

At block 130, the unique customer identification information is linked with the current purchase at the customer record.

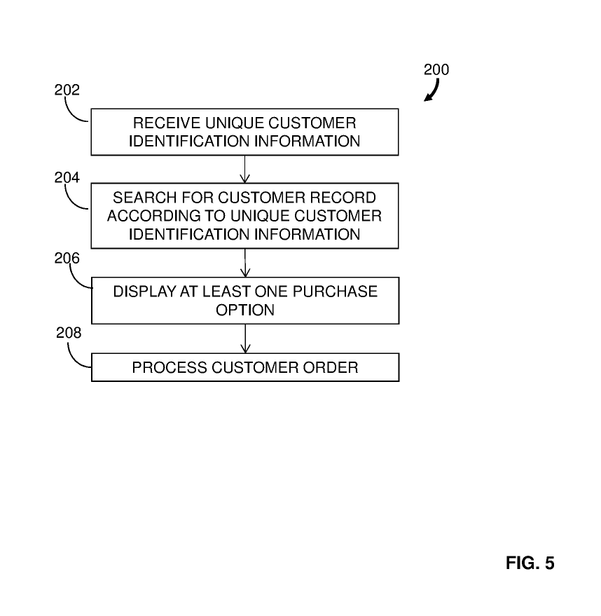

FIG. 5 is a flow diagram illustrating a method 200 for purchasing at a store checkout, in accordance with some embodiments. Some or all of the method 200 can be performed at the store 10 illustrated in FIG. 1. Accordingly, in describing the method 200, reference is made to FIGS. 1-4. Alternatively, some or all of the method 200 can be performed at a kiosk or other public apparatus, such as an airport or shopping mall kiosk. Alternatively, some or all of the method 200 can be performed as part of an online payment processing system.

At block 202, unique customer identification information is received by the retail checkout system 14, for example, in accordance with embodiments of the method 100 described with respect to FIG. 3. At block 204, a search for the customer record can be performed according to the unique customer identification information, for example, comparing customer identification information on a purchaser card with the customer record. In some embodiments, biometric data such as an image of the customer's face can he captured using a camera or the like at the retail checkout system 14, and compared to a previously stored image provided with the customer record stored at the customer registration database 18.

At block 206, at least one purchase option is displayed, for example, at the retail checkout system 14.

One purchase option can include a recommendation cart that is generated from the customer record and from other customer-related data, such as purchase history information and so on. The recommendation cart provides a list of items that are recommended for purchase based on the customer's shopping history. For example, the recommendation cart allows the customer to receive recommended shopping lists that are recurring in a regular routine, such as a daily routine or weekly routine.

Another purchase option can include a search inventory option, which can be displayed so that the customer may search for an item in the store inventory, for example, stored at the customer registration database 18. Here, the customer can type a keyword for selection criteria and select a search button, whereby the system displays a list of items according to the selection criteria. Selected items can be automatically added to the customer record for future presentation of the selected items in a generated recommendation cart.

Another purchase option can include a purchase history option. Customers can quickly browse their purchase history, and view recurring items. A customer can select those items of interest for a current purchase.

At block 232, a pick route map may be displayed. A pick route map can be a system generated map of all the items in the customer's cart. The store can be divided into predetermined categories or sections, such as frozen section, produce section, and so on. In each category there are multiple aisles. In each aisle, there are multiple shelves. Every item can be associated with a shelf-aisle-category combination. Based on this information, the system can generate the pick route map of all the items in the cart, for example, according to a minimum distance and time.

At block 208, the customer order is processed. The order is processed after the customer has an opportunity to review the recommendation cart, search for inventory, review purchase history, and/or identify delivery options such as self-picking, so that items in addition to those to the items previously identified for purchase by the customer may be added to the order. After the customer order is processed, the purchase data can be added to the customer record, and stored at a storage device.

The foregoing customer purchase order information, can be saved so that when the customer 17 shops again at the store 10, the customer can subsequently browse through purchase history, system recommended items, and store inventory using the captured customer information and/or previous order information,

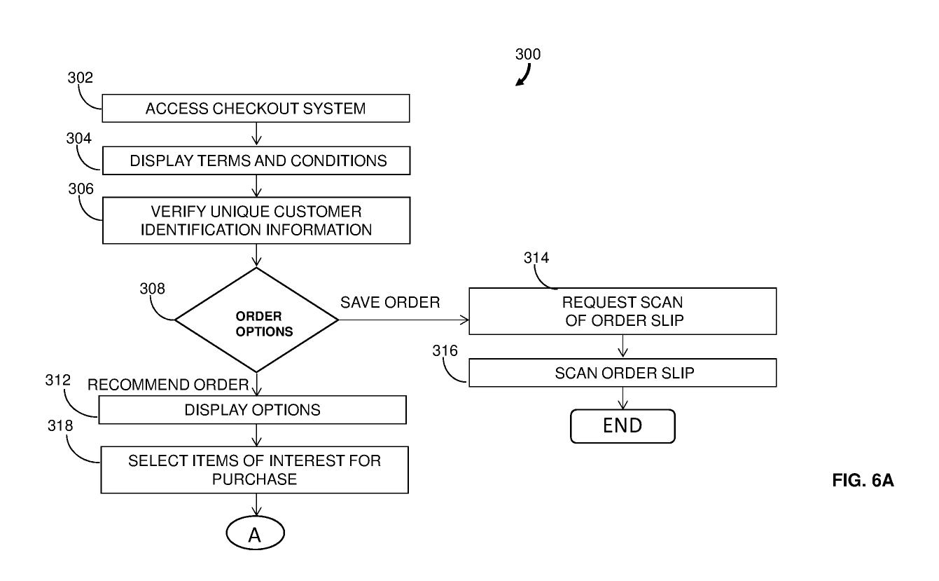

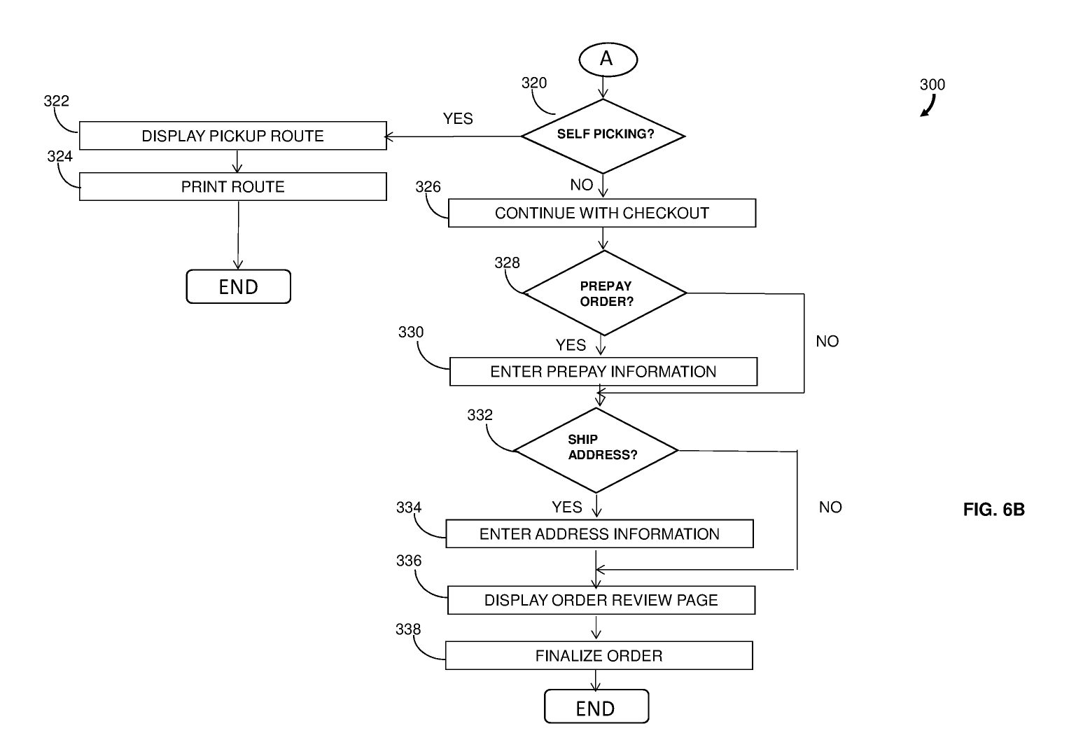

FIGS. 6A and 6B are flow diagrams illustrating a method 300 for operating a retail checkout system, in accordance with some embodiments. Some or all of the method 300 can be performed at the store 10 illustrated in FIG. 1. Accordingly, in describing the method 300, reference is made to FIGS. 1-5. Alternatively, some or all of the method 300 can be performed at a kiosk or other public apparatus, such as an airport or shopping mail kiosk. Alternatively, some or all of the method 300 can be performed as part of an online payment processing system.

At block 302, a customer accesses the retail checkout system 14, for example, similar to method 100 described with respect to FIG. 3. For example, a customer may enter a name or other identifier at a keyboard or other input/output device of the retail checkout system 14, which in turn accesses the customer account,

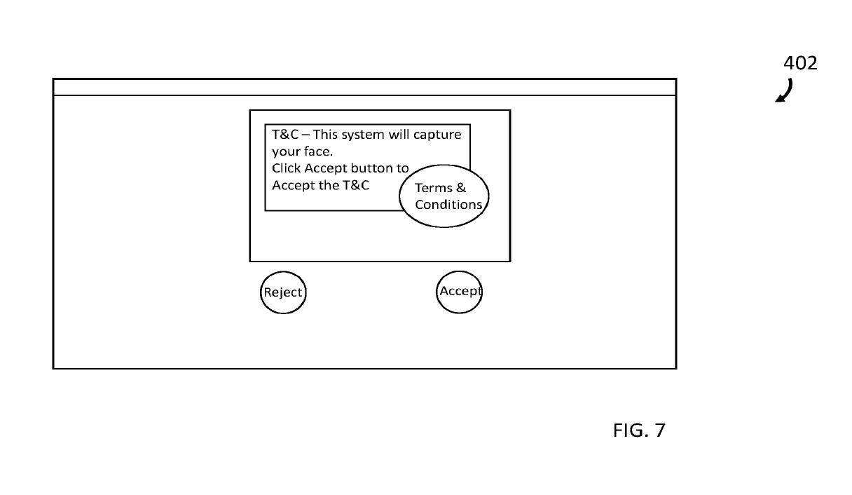

At block 304, a set of terms and conditions may be displayed, for example, shown in the screenshot 402 of FIG. 7. Example terms and conditions may inform the viewer of the collection of personal information related to the personal card used in a purchase. The customer 17 may have the option of accepting or rejecting the displayed terms and conditions.

If the customer agrees with the terms and conditions, then the method 300 proceeds to block 306, where the customer's unique customer identification information is verified, for example, purchaser card information and/or biometric data can be captured by input devices of the retail checkout system 14, and compared to a customer record that includes previously recorded information about the customer to confirm the identity of the customer. For new customers, a customer record is created as described in the method 120 of FIG. 4.

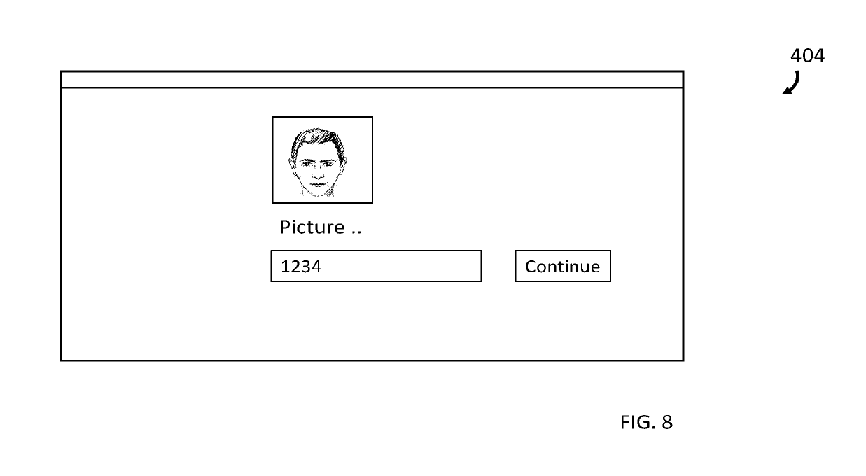

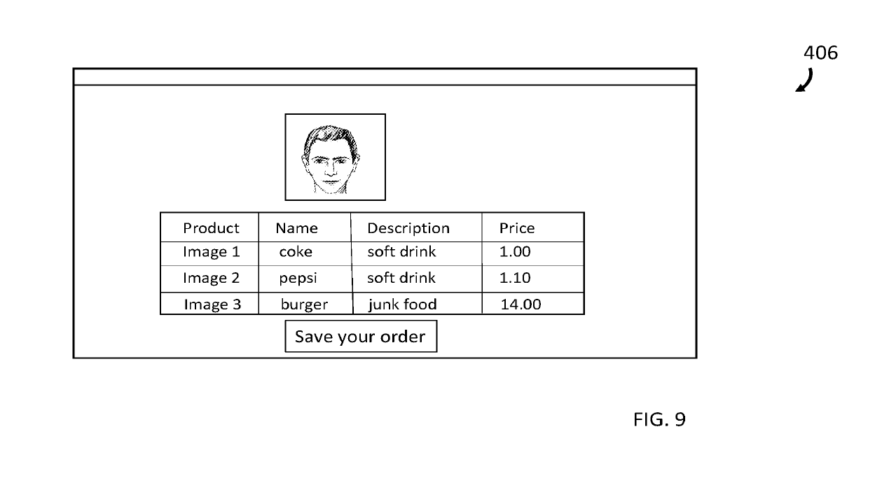

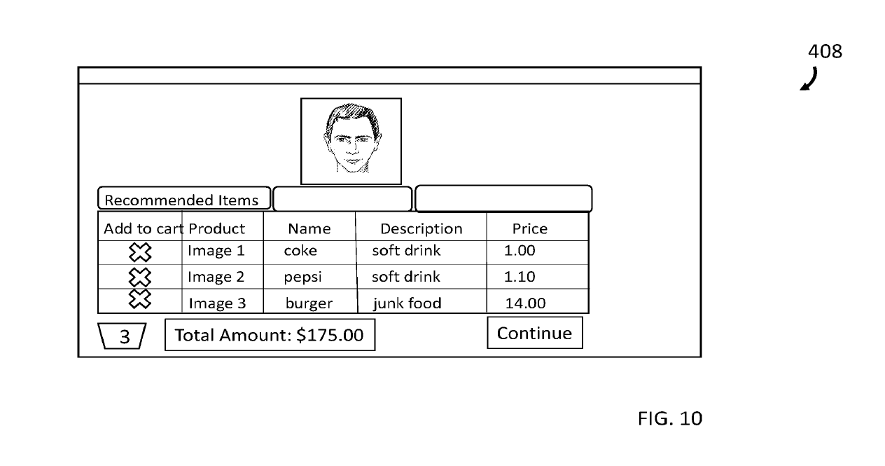

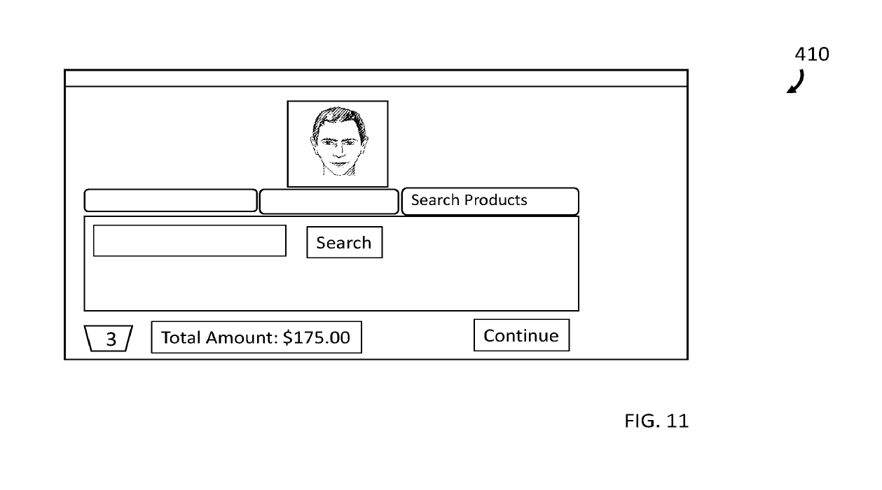

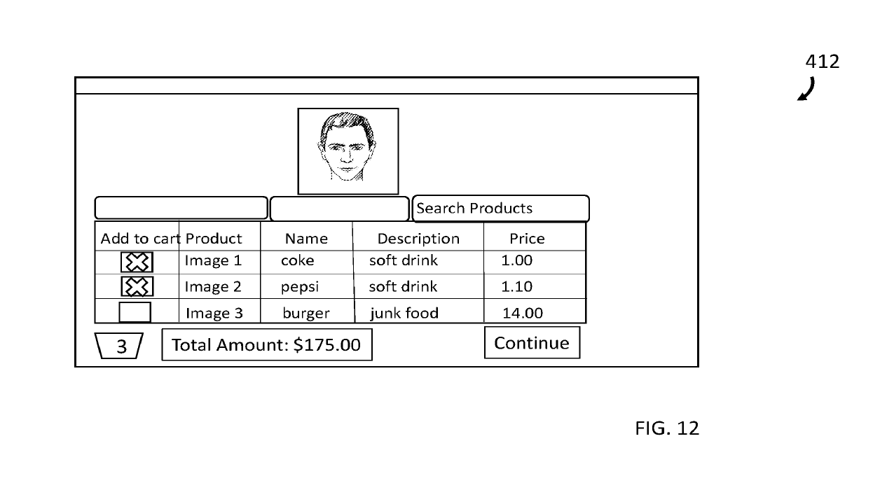

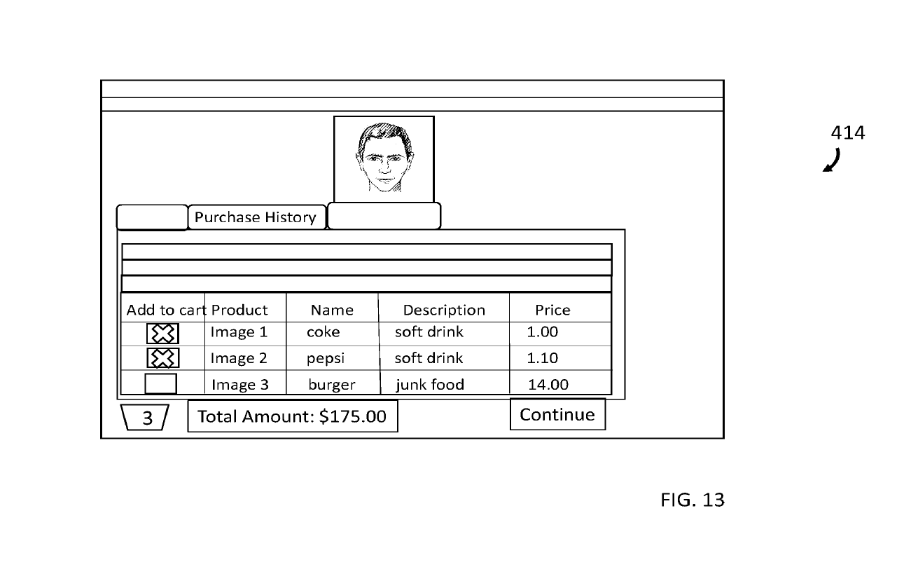

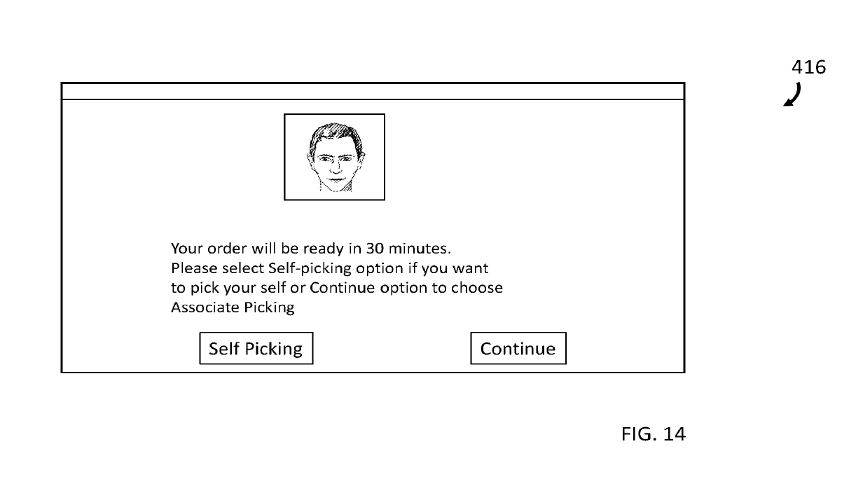

At decision diamond 308, the customer can select an order option, for example a recommend order (block 312) or a save order (block 314). Screenshots 404, 406 of a process for displaying order information are shown at FIGS. 8 and 9, respectively. At block 312, the system 14 displays one or more options, including but not limited to a recommendation cart based on the customer's purchase history or related customer information. An example of a recommendation cart is shown in the screenshot 408 of FIG. 10. An example of a search inventory option is shown in screenshots 410, 412 of FIGS. 11 and 12, respectively. An example of a purchase history option is shown in screenshots 414, 416 of FIGS. 13 and 14, respectively.

If at decision diamond 308 a save order is selected, then the method 300 proceeds to block 314, where request for a scan of the order slip is made. At block 316, the order slip is scanned.

Returning to block 312, at the recommendation cart, the customer can select items of interest for purchase from the recommendation cart, which may be in addition to, or instead of, the other items of interest that the customer wishes to purchase from the current store visit.

At block 318, an item of interest is selected for purchase by the customer 17 at the display device 36.

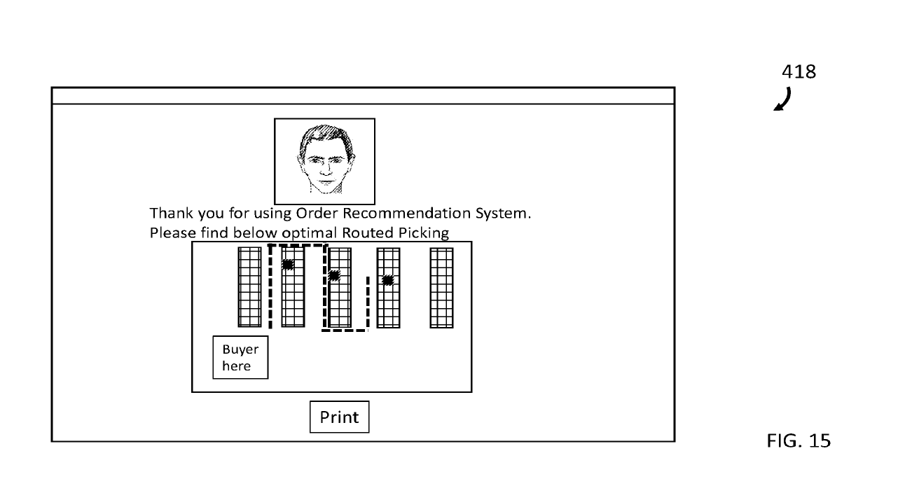

At decision diamond 320, a determination is made whether to self-pick or whether to continue with the system checkout process. If the customer selects the self-pick option at the display device 36, then the method 300 proceeds to block 322, where the system displays the best route to pick the selected items. A self-pick option can be provided in situations when the customer has a few items in his/her cart and wishes to save time during a shopping experience. In some cases, a customer may elect to self-pick if an associate pick is taking longer time to pick items. In a self-pick option, the system will show the best route of all the items in the cart to the customer from where he/she standing. At block 324, the selected route may be printed, for example, output from the system to a printer, a display, or other output device so that the user/customer may visually observe the route details. If at decision diamond 320, the customer selects the option for continuing the checkout process, then the method 300 proceeds to block 326 where the checkout process continues. An example of a self-picking option is shown in screenshots 416, 418 of FIGS. 14 and 15, respectively.

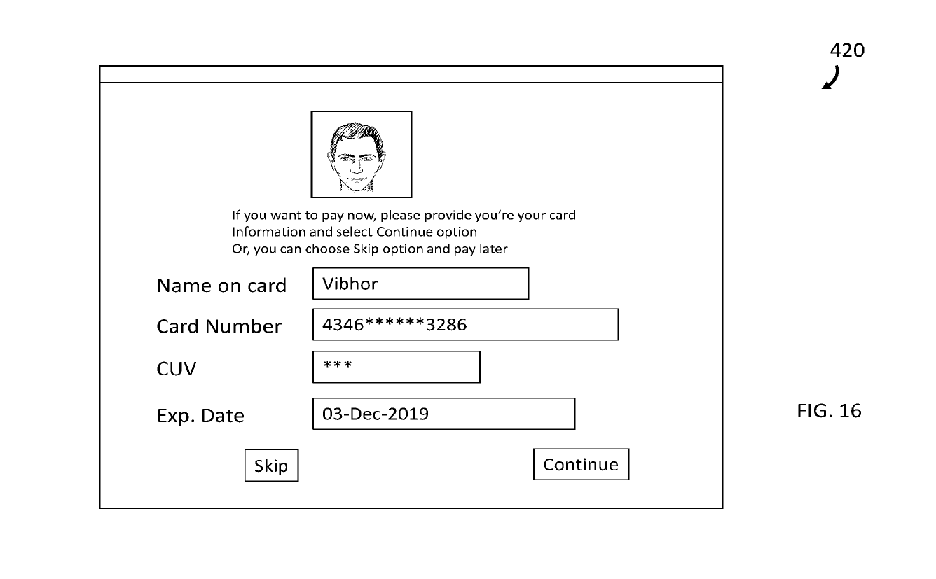

At decision diamond 328, a determination is made whether to prepay the order. If a determination is made to prepay the order, then the method 300 proceeds to block 330, where the customer can enter credit card or debit card information, or other data that permits payment to be made electronically for the purchased items, for example, a bank routing number and so on. Other payment options can equally apply, for example, cash purchases. An example is shown in screenshot 420 of FIG. 16. Otherwise, if the customer elects not prepay, for example, by selecting an option that indicates “no prepay,” then the method 330 proceeds directly to decision diamond 332, where a determination is made to ship to an address.

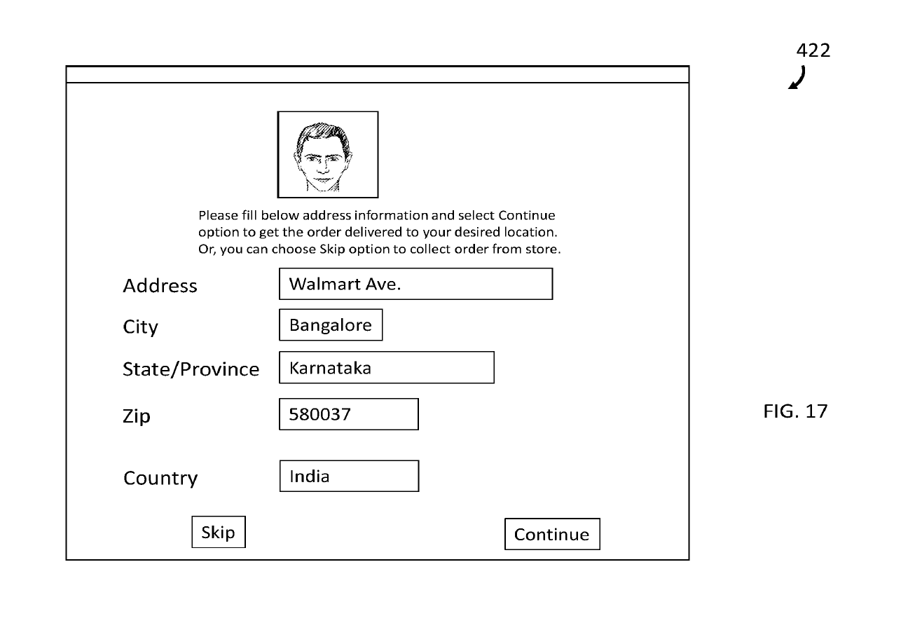

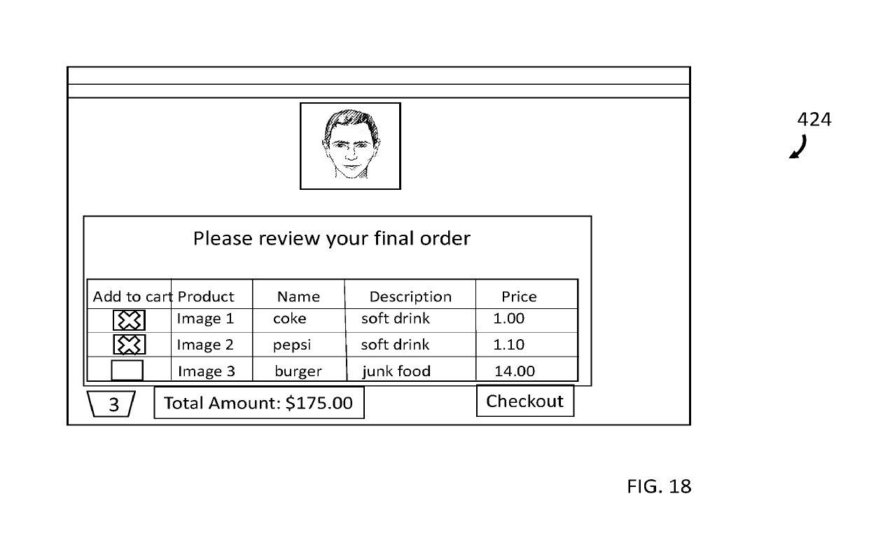

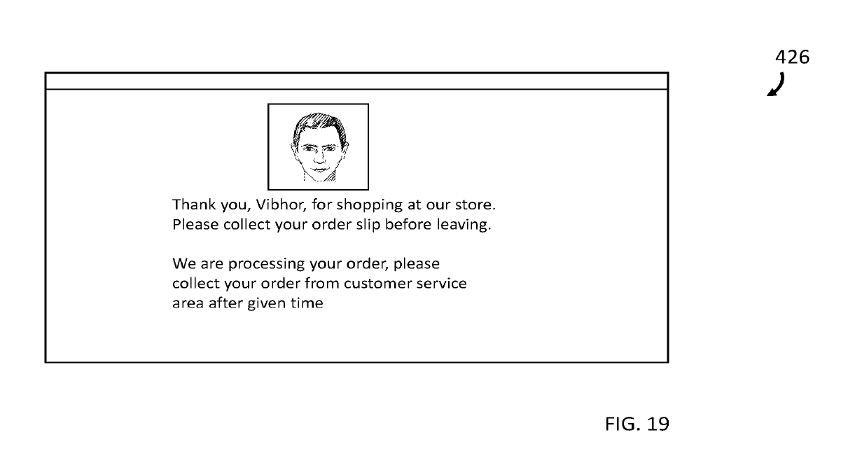

At decision diamond 332, a determination is made whether to ship the order to a particular address. If the customer wishes to ship the order to a particular address, the method 300 proceeds to block 334 where the customer can enter shipping address information, for example, shown in screenshot 422 of FIG. 17. Otherwise, the method 300 proceeds directly to block 336, where a display order review page is displayed, for example, shown in screenshot 424 of FIG. 18, then to block 338 where the checkout process is completed, for example, shown in screenshot 426 of FIG. 19. Purchase information, updated purchaser card information, shipping details, and/or other data generated during the method 300 can be saved, and stored at a data repository such as the customer registration database 18.

Accordingly, a retail checkout system and method in accordance with one or more embodiments here can be provided at a store or other public place such as a mall, station, where customers can shop quickly. Another feature is that a store can track sales records of frequent customers who do not have membership cards. The store can also recommend items to customers who do not have Internet access, or who do not provide mailing addresses for advertisements, but are nevertheless frequent buyers at the store. The retail checkout system and method also permits a customer to submit an initial order for purchase, and to continue shopping or other activities while the order is being processed, for example, the items are being collected for pickup.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following

1. A retail checkout system, comprising:
a customer registration database that stores a plurality of customer records, wherein a customer record of the plurality of customer records includes registered identification information related to a store customer;
an input device that receives unique customer identification information from a purchaser card of the store customer;
a customer identification analyzer that verifies that the received unique customer identification information is included in the registered identification information of the customer record;
an order linking module that associates purchase data with the unique customer identification information of the purchaser card; and
a customer record processor that updates the customer record to include the purchase data.

2. The retail checkout system of claim 1, further comprising an order processor that receives
the purchase data from the input device and outputs the purchase data to the order linking module for associating the purchase data with the unique customer identification information of the purchaser card.

3. The retail checkout system of claim 1, wherein the input device communicates with a point-of-sale device to receive at least one of the purchase data and the unique customer identification information or the input device includes a point of sale device for receiving at least one of the purchase data and the unique customer identification information.

4. The retail checkout system of claim 1, wherein the customer record processor creates a new customer record from the unique customer identification information recorded on the purchaser card in response to a determination that the customer identification analyzer fails to verify that the received unique customer identification information is included in the registered identification information of the customer record.

5. The retail checkout system of claim 1, wherein the purchaser card includes at least one of a credit card, a debit card, a driver's license, a social security card, a passport, a membership card, or an identification card.

6. The retail checkout system of claim 1, wherein the unique customer identification information includes at least one of a name, an address, a date of birth, an identification number, an account number, or a phone number.

7. The retail checkout system of claim 1, wherein the input device receives unique customer identification information from a plurality of purchaser cards of the store customer, and wherein the customer record processor updates the customer record to include the unique customer identification information from each of the plurality of purchaser cards, and purchase data related to each of the purchase cards.

8. The retail checkout system of claim 1, further comprising a recommendation cart generator that generates a list of recommended store items for purchase based on historical purchase data in the customer record.

9. The retail checkout system of claim 1, further comprising an inventory search engine that generates available store items based on a search result of a store inventory database.

10. The retail checkout system of claim 1, further comprising a purchase history generator that receives and outputs store customer purchase history data from the customer record to a display.

11. The retail checkout system of claim 1, wherein the retail checkout system is deployed at a brick-and-mortar store checkout, a kiosk at a public location, or an online checkout.

12. The retail checkout system of claim 1, wherein the store customer registration database includes purchaser information from a plurality of stores.

13. The retail checkout system of claim 1, wherein the input device collects biometric data related to the store customer, and compared to the registered identification information in the customer record for identifying the store customer.

14. A checkout kiosk, comprising:
an input device that receives unique customer identification information from a purchaser card;
a customer identification analyzer that verifies the received unique customer identification information;
an order linking module that associates purchase data with the unique customer identification information of the purchaser card; and
a customer record processor that updates the customer record to include the purchase data.

15. The checkout kiosk of claim 14, wherein the input device communicates with a point-of-sale device to receive at least one of the purchase data and the unique customer identification information or the input device includes a point of sale device for receiving at least one of the purchase data and the unique customer identification information.

16. The checkout kiosk of claim 14, wherein the checkout kiosk is deployed at a brick-and-mortar store checkout or a public location.

17. The checkout kiosk of claim 14, further comprising a recommendation cart generator that generates a list of recommended store items for purchase based on historical purchase data in the customer record.

18. The checkout kiosk of claim 14, further comprising an inventory search engine that generates available store items based on a search result of a store inventory database.

19. The checkout kiosk of claim 14, further comprising a purchase history generator that receives and outputs store customer purchase history data from the customer record to a display.

20. A method for purchasing store items, comprising:
receiving at an input device unique customer identification information from a purchaser card;
verifying the received unique customer identification information;
associating purchase data with the unique customer identification information of the purchaser card; and
updating the customer record to include the purchase data.

21. The method of claim 20, further comprising:
performing at least one purchase-related action in response to a determination that the card is linked to the information related to the purchaser stored at the store customer registration database.

22. The method of claim 20, wherein the at least one purchase-related action includes displaying a purchase history of the purchaser.

23. The method of claim 20, wherein the at least one purchase-related action includes searching a database for store inventory.

24. The method of claim 20, wherein the store checkout is a brick-and-mortar store checkout, a kiosk at a public location, or an online checkout.

25. The method of claim 20, further comprising:
collecting, at the store checkout, biometric data related to the purchaser, wherein the biometric data is linked to the information related to the purchaser stored at the store customer registration database.

26. The method of claim 20, further comprising creating a new customer record from the unique customer identification information recorded on the purchaser card in response to a determination that the customer identification analyzer fails to verify that the received unique customer identification information is included in the registered identification information of the customer record.
